(19) United States
(12) Patent Application Publication
(10) Pub. No.: US 2025/0129830 A1
(43) Pub. Date: Apr. 24, 2025

(54) MANUFACTURING METHOD FOR A WORKPIECE WITH A REFINEMENT LAYER, AND WORKPIECE WITH A REFINEMENT LAYER

(71) Applicant: HPL TECHNOLOGIES GMBH, Aachen (DE)

(72) Inventor: Tobias Phillip UTSCH, Wetzlar (DE)

(73) Assignee: HPL TECHNOLOGIES GMBH, Aachen (DE)

(21) Appl. No.: 18/683,721

(22) PCT Filed: Aug. 16, 2022
(86) PCT No.: PCT/DE2022/100606

§ 371 Date: Feb. 14, 2024

(30) Foreign Application Priority Data
Aug. 16, 2021 (DE) 10 2021 208 973.9

(51) Int. Cl. F16D 65/12; C21D 1/30; F16D 65/02; F16D 69/04

(52) U.S. Cl. CPC F16D 65/127; F16D 69/04; C21D 1/30; F16D 2065/132; F16D 2069/0466; F16D 2069/0483; F16D 2250/0023; F16D 2250/0038; F16D 2250/0069

(57) ABSTRACT

The invention relates to a finishing method for a workpiece with a finishing layer, having the following steps: a. providing a workpiece with a treatment surface; and b. providing the treatment surface with a finishing layer. The finishing method is primarily characterized in that the method has at least the following step: c. reducing stresses in the finishing layer. The invention additionally relates to a workpiece with a finishing layer, wherein the finishing layer is re-compressed and/or the stress in the finishing layer is neutral or a compressive stress. By virtue of the aforementioned finishing method and the workpiece, a high quality and a long service life of the finishing layer can be achieved using inexpensive means.

The invention relates to a manufacturing method for a workpiece with a refinement layer, and workpiece with a refinement layer.

In the prior art, it is known to provide a workpiece with a refinement layer, for example a brake disc with a friction coating by means of high-speed flame spraying and/or by means of a diffusion method. As a result of the thermal input during the application of the refinement layer, localised stresses and partial deformation of the workpiece occur.

For example, it is known that in brake discs, so-called shielding occurs, in which the radially outer edge is higher relative to the radially inner edge normal to the (ideal) surface. In some workpieces, this is accepted and in others it is compensated for by downstream machining methods. As soon as chip removal is necessary, a corresponding allowance must be made, which increases the amount of material, mass and production time.

The stresses induced between the refinement layer and the treatment surface during manufacturing also place a load on the bond between the refinement layer and the treatment surface, such that the bond strength for an additional mechanical load during operation of the workpiece can lead to premature detachment of the refinement layer.

Starting from here, the object upon which the present invention is based is to overcome at least partially the disadvantages known from the prior art. The features according to the invention result from the independent claims, for which advantageous embodiments are shown in the dependent claims. The characteristics of the claims can be combined in any technically sensible manner, wherein in this regard the explanations from the following description as well as characteristics from the figures can also be used to produce supplemental embodiments of the invention.

The invention relates to a manufacturing method for a workpiece with a refinement layer, comprising the following steps:
a. providing a workpiece with a treatment surface; and
b. providing the treatment surface with a refinement layer.

The manufacturing method is characterised in particular in that it further comprises at least the following step:
c. reducing stresses in the refinement layer.

Hereinafter, reference will be made to the mentioned axis of rotation when, without an explicit indication to the contrary, the axial direction, radial direction or the circumferential direction and corresponding terms are used. Ordinal numbers used in the previous and following description serve, insofar as there is no indication to the contrary, only for clear distinguishability and do not reflect any sequence or priority of the described components. An ordinal number greater than one does not mean that a further component of this sort necessarily needs to be present.

A manufacturing method for a workpiece with a refinement layer is proposed here, in which the refinement layer is applied to the treatment surface. Such a refinement layer is, for example, a friction layer with carbides and/or a corrosion protection layer, for example for exterior areas in a motor vehicle or a seawater application. It is in this case proposed that no post-machining is carried out, but rather the stresses in the refinement layer, and preferably also in the treatment surface, of the workpiece are reduced. If the stresses are reduced, the fatigue strength of the bond between the refinement layer and the treatment surface is improved because forces introduced from the outside, for example a shear moment during the braking process on a brake disc, do not accumulate on an existing stress. In a particularly preferred embodiment, the stresses are reduced to such an extent that a compressive stress, that is a stress which in an exaggerated case would lead to convex deformation with the surface of the workpiece, is induced in the refinement layer in relation to the treatment surface. This means that the amount of stress is subtracted from an external load, thus reducing the effect of the external load on the bond between the refinement layer and the treatment surface.

It is further proposed in an advantageous embodiment of the manufacturing method that in step c. the stresses in the refinement layer, and preferably also in the treatment surface, are reduced by means of at least one of the following methods:
stress-relief annealing;
roller-burnishing;
hammering;
pressing.

A particularly advantageous embodiment of the manufacturing method is implemented with stress-relief annealing, wherein stresses introduced by thermal post-treatment with the refinement layer and part of the treatment surface are released.

Alternatively, mechanical processing of the refinement layer (with an effect on the underlying treatment surface) is proposed, in which the refinement layer and optionally at least part of the treatment surface is compressed. The compression causes a reduction in the tensile stresses in the refinement layer or between the refinement layer and the treatment surface or in the treatment surface alone to the point where compressive stress is built up. Another advantage of mechanical processing is that the microstructure is not or only insignificantly altered during this cold forming process, meaning that even demanding refinement layers or materials on the treatment surface can be processed. During roller-burnishing, the refinement layer is compressed with a roller-like body, during hammering with a flat blow and during pressing with a (preferably full-surface) compressive load on the refinement layer and optionally the treatment surface.

It is further proposed in an advantageous embodiment of the manufacturing method that at least one of the following properties is further achieved in comparison to the coating result by means of step b:
a reduced roughness; and
an increased surface density,
wherein preferably this at least one property is achieved in step c.

It is proposed here that the roughness of the refinement layer is reduced and/or the surface density of the refinement layer (and preferably the treatment surface) is increased. Due to the reduced roughness, a post-treatment step, for example with machining, is superfluous or reduced, which means that shorter machine times and smaller quantities of material are useable. Due to the increased surface density, not only the strength of the refinement layer (or the treatment surface) is achieved, but also an improvement of the bond between the refinement layer and the treatment surface is achievable. This means that a higher long-term strength is achievable and/or the amount of material used is reduceable.

In an advantageous embodiment, the roughness of the refinement layer is only reduced to the extent that the relatively soft materials of a matrix, in which hard materials, for example carbides, are incorporated, are levelled and the embedded hard materials are not levelled or are levelled to a lesser extent when the roughness is reduced, so that, for example for a brake disc, the carbides are firmly embedded in the matrix material, which is then, for example, compressed, and optimally participate in the braking action.

In a preferred embodiment, for aforementioned properties are achieved by reducing the stresses in step c. described above, preferably by means of a mechanical compression process such as roller-burnishing, hammering or pressing. It should be noted that step c. may also comprise a plurality of methods such as stress-relief annealing and subsequent mechanical cold forming.

In an advantageous embodiment, the refinement layer comprises an adhesive layer and a functional layer, preferably a friction layer, wherein the adhesive layer is arranged between the treatment surface and the functional layer.

According to this embodiment, an adhesive layer is preferably first applied to the treatment surface and a functional layer is applied on top of it, that is on the side facing away from the workpiece. The adhesive layer is preferably designed to ensure that the friction layer has a stable hold. The friction layer is designed, for example, to provide a specific coefficient of friction with respect to a mating element, such as a brake shoe.

According to an advantageous embodiment, in step c. the stresses in the adhesive layer, preferably exclusively in the adhesive layer with respect to the refinement layer, are reduced.

Preferably, step c. is carried out after the adhesive layer has been applied and before the friction layer is applied.

According to a further aspect, a workpiece with a refinement layer is proposed, wherein the workpiece has a support body with a treatment surface, wherein a refinement layer is applied to the treatment surface.

The workpiece is characterised in particular by the fact that the refinement layer is re-compressed.

A workpiece with a refinement layer is now proposed here, for example a brake disc as explained at the outset, wherein the workpiece comprises a support body, preferably a cast body, on which the treatment surface forms at least a sub-region of the surface of the support body. A refinement layer is applied to this treatment surface, for example by high-velocity oxygen fuel spraying [HVOF] or laser deposition welding, particularly preferably extreme high-speed laser deposition welding [EHLA]. It is now proposed here that the refinement layer is re-compressed, that is re-compressed by means of a thermal or mechanical (cold forming) method after the refinement layer has been applied to the treatment surface. This property is already detectable from the outside on the surface of the workpiece processed in this way, or at least in a section or by means of other (non-destructive) testing methods. For the process of producing such a workpiece, reference is made to the above description of the manufacturing methods.

According to a further aspect, a workpiece with a refinement layer is proposed, wherein the workpiece has a support body with a treatment surface, wherein a refinement layer is applied to the treatment surface.

The workpiece is characterised in particular by the fact that the stress in the refinement layer is neutral or a compressive stress.

Here, in a variant or also in the same embodiment, a workpiece with the same basic requirements is proposed, wherein a support body with a treatment surface thus has a refinement layer. In this respect, reference is made to the preceding description. It is now proposed here that the stress in the refinement layer is neutral or is a compressive stress. Preferably, the stress in the treatment surface at least near the refinement layer is also neutral or a compressive stress. This is achievable cost-effectively using a thermal method (e.g. stress-relief annealing) or a mechanical method (cold forming). In a preferred embodiment, the stress in the refinement layer (or the treatment surface) is both neutral or a compressive stress and also re-compressed. In an advantageous embodiment, the stress in the refinement layer, and preferably also in the treatment surface, is evenly distributed and a maximum deviation is a maximum of 15% [fifteen percent], preferably less. With respect to the production and advantages, reference is made to the preceding description.

It is further proposed in an advantageous embodiment of the workpiece that the workpiece is manufactured by means of a manufacturing method according to an embodiment as in the description above.

It is further proposed in an advantageous embodiment of the workpiece that the workpiece is a rotary workpiece with an axis of rotation, preferably a brake disc for a motor vehicle.

Here it is proposed that the workpiece is a rotary workpiece, wherein the rotary workpiece is rotated about a central axis of rotation when the refinement layer is applied. A single feed axis is then often sufficient for the coating unit in order to apply the refinement layer. When the treatment surface has a cylindrical shape, this feed axis is aligned parallel to the axis of rotation (corresponds to the cylinder axis). In the case of a cylinder cover shape, or disc shape, of the treatment surface, this feed axis is aligned parallel to the radius with respect to the axis of rotation (corresponds to the cylinder axis or disc axis). Preferably, furthermore, a delivery axis or adjusting axis is provided, wherein especially preferably this is moveable in a manner adapted to the coating speed or to the measuring speed in the coating process or during the calibration. Alternatively, the delivery axis is moveable more slowly and is set only prior to the start of an application of the refinement layer or of a calibration or of an intermediate step of the procedure concerned.

In an advantageous embodiment, the rotary work piece is a brake disc for a motor vehicle (including a utility vehicle). The treatment surface is the friction surface which during operation comes into contact with a brake pad when the motor vehicle decelerates. The carrier disc is for example cast, for example from steel or lamellar grey cast iron. The refinement layer comprises carbides which ensure a desired surface roughness and friction resistance of the refined surface. For example, the refinement layer is a MMC (metal matrix composite), preferably comprising stainless steel as a matrix material. The additives are for example niobium [Nb], silicon [Si], chromium [Cr] and/or titanium [Ti]. In one embodiment, the refinement layer is composed of two or more layers of material with different compositions, wherein a binding layer and a friction layer are provided, for example (preferably exclusively). For the general technical background, reference is made to DE 10 2018 120 897 A1.

In an advantageous embodiment, the brake disc has shielding with a maximum height difference of 10 μm [ten micrometres] to 200 μm on the outer diameter of the rotary workpiece. Thus, such shielding is in a range permissible for the final state of the brake disc and it is not necessary to remove material from the refinement layer due to the shielding. Alternatively, the height of material to be removed is in the same range as that required to compensate for undulation and/or a maximum difference between the height minimum and the height maximum, wherein the measurement method described above is preferably used to ensure that the effects do not accumulate. A workpiece with such an accumulation is discarded as a reject or (in individual cases) a greater layer height is applied or a height minimum is subsequently filled in deliberately. The latter is possible with the measuring method described above because the measuring unit (and the coating unit) are referenced to the workpiece and therefore the exact position of the height minimum is known.

In an advantageous embodiment, the refinement layer comprises an adhesive layer and a functional layer, preferably a friction layer, wherein the adhesive layer is arranged between the treatment surface and the functional layer.

In an embodiment, the adhesive layer, preferably exclusively the adhesive layer with respect to the refinement layer, is re-compressed and/or the stress in the adhesive layer, preferably exclusively the adhesive layer, is neutral or a compressive stress. The above-described invention is hereinafter described in detail against the corresponding technical background with reference to the attached drawings, which show preferred embodiments. The invention is in no way limited by the purely schematic drawings, wherein it is to be noted that the drawings are not to scale and are not suitable for the definition of proportions. Shown are in

FIG. 1: a flowchart of a manufacturing method for a workpiece with a refinement layer;

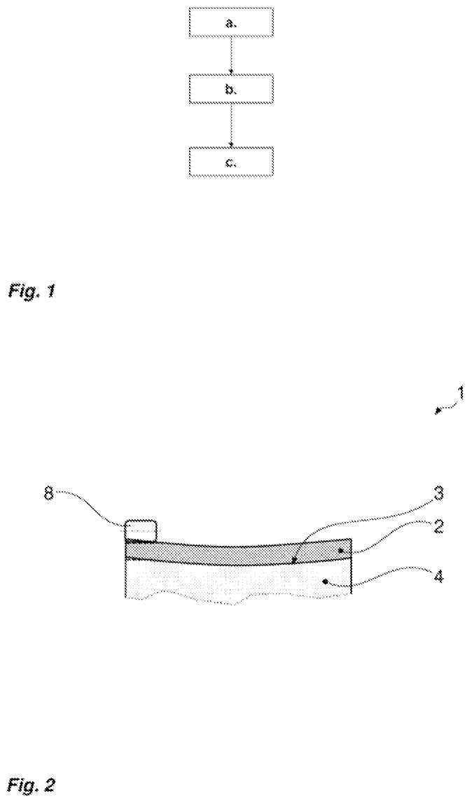

FIG. 2: a workpiece during step c. of the manufacturing method according to FIG. 1;

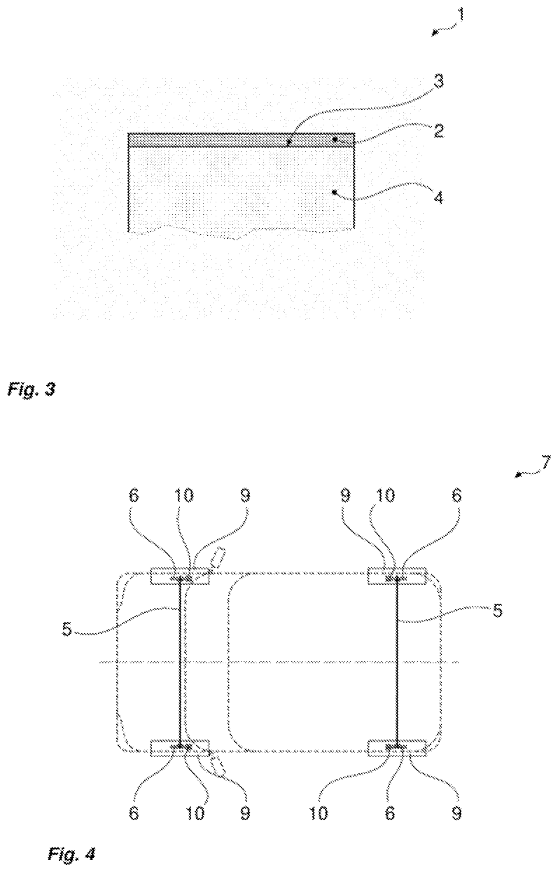

FIG. 3: the workpiece according to FIG. 2 after step c. of the manufacturing method; and

FIG. 4: a motor vehicle with brake discs in a schematic top view.

FIG. 1 shows a flowchart of a manufacturing method for a workpiece 1 with a refinement layer 2. In step a., a workpiece 1 with a treatment surface 3 is provided. For example, the workpiece 1 is a rotary workpiece with an axis of rotation 5, such as a brake disc 6 (see FIG. 4).

In a subsequent step b., the treatment surface 3 is provided with a refinement layer 2, for example using a suitable automated coating device. Such a refinement layer 2 comprises, for example, an adhesive layer and/or a friction layer with carbides and/or an anti-corrosion layer.

In a final step c., the stresses in the refinement layer 2, and optionally also in the treatment surface 3, of the workpiece 1 are reduced. If the stresses are reduced, the fatigue strength of the bond between the refinement layer 2 and the treatment surface 3 is improved because forces introduced from the outside, for example a shear moment during the braking process on a brake disc 6, do not accumulate on an existing stress. Preferably, tensile stresses are reduced or converted into compressive stresses. Preferably, the stresses on the adhesive layer are reduced.

FIG. 2 shows a workpiece 1 during step c. of the manufacturing method according to FIG. 1. The workpiece 1 comprises a support body 4, purely optionally a cast body, on which the treatment surface 3 of the support body 4 is arranged at the top as illustrated. A refinement layer 2 with a (specific) surface density is applied to this treatment surface 3, for example by extreme high-speed laser deposition welding [EHLA]. As a result of the thermal input during the application of the refinement layer 2, local stresses and deformations of the workpiece 1 occur, so that the workpiece 1 shown here has a deflection due to tensile stresses in the refinement layer 2 (and consequently also in the treatment surface 3).

In the illustrated step c., the refinement layer 2 is now re-compressed purely optionally by means of mechanical cold forming, for example a roller burnishing device 8 in the form of a cylindrical roller. Purely optionally, for this purpose, the roller burnishing device 8 is rolled over the refinement layer 2 in predefined paths with a predefined contact pressure, wherein the roller burnishing device 8 presses into the refinement layer 2 (the roller burnishing device 8 is therefore shown overlapping with the refinement layer 2) and re-compresses it. Purely optionally, the material underneath the treatment surface 3 is also re-compressed. The compression causes a reduction in the tensile stresses in the refinement layer 2 or between the refinement layer 2 and the treatment surface 3.

During cold forming, the roughness of the refinement layer 2 is also reduced and, purely optionally, the surface density of the refinement layer 2 and, purely optionally, of the treatment surface 3 is increased. The reduced roughness eliminates the need for a post-treatment step, for example with machining, or reduces the effort involved, which means that shorter machine times are required and smaller quantities of material are useable. Due to the increased surface density not only the strength of the refinement layer 2 (or the treatment surface 3) is achieved, but also an improvement of the bond between the refinement layer 2 and the treatment surface 3 is achievable. This means that a higher long-term strength is achievable and/or the amount of material used is reducible.

FIG. 3 shows the workpiece 1 according to FIG. 2 after step c. of the manufacturing method. It can be clearly seen here that the stress in the refinement layer 2 is neutral. Purely optionally, the stress in the treatment surface 3 is also neutral at least near the refinement layer 2. This is implemented cost-effectively using the mechanical method (see FIG. 2), thus reducing or even cancelling out any deformation of the workpiece 1 as a result of the application of the refinement layer 2 and, possibly, even inducing compressive stress.

FIG. 4 shows a motor vehicle 7 with brake discs 6 in a schematic top view. The motor vehicle 7 has four wheels 9, wherein two wheels 9 are arranged opposite each other on a common wheel axis (congruent with the axis of rotation 5 of the brake discs 6). In this example, each of the wheels 9 has a brake disc 6 with an axis of rotation 5, wherein the wheel 9 and brake disc 6 are connected in a torque-fixed manner.

For example, a refinement layer 2 is applied to each of the two axially opposite sides of the brake disc 6 by means of the manufacturing method shown in FIG. 1. A pair of brake pads 10 is associated with each of the brake discs 6, wherein the brake pads 10 are firmly connected to the vehicle body. To decelerate the motor vehicle 7, a respective brake pad 10 is pressed (each or individually controlled) against the respective brake disc 6. A large part of the braking energy is introduced into the respective brake disc 6 as waste heat, which is why the coating layer 2 is subjected to high temperatures, high shear loads and high pressure. The coating layer 2 must be able to withstand this type of load.

A high quality and a long service life using cost-effective means are achievable with the manufacturing method and workpiece proposed here.

### LIST OF REFERENCE NUMERALS

1 Workpiece
2 Refinement layer
3 Treatment surface
4 Support body
5 Axis of rotation
6 Brake disc
7 Motor vehicle
8 Roller burnishing device
9 Wheel
10 Brake pad

1-11. (canceled)

12. Manufacturing method for a workpiece with a refinement layer, comprising the following steps:
a. providing a workpiece with a treatment surface; and
b. providing the treatment surface with a refinement layer,
wherein
the method further comprises at least the following step:
c. reducing stresses in the refinement layer.

13. Manufacturing method according to claim 12, wherein
in step c. the stresses in the refinement layer, and preferably also in the treatment surface, are reduced by means of at least one of the following methods:
stress-relief annealing;
roller-burnishing;
hammering;
pressing.

14. Manufacturing method according to claim 12, wherein
at least one of the following properties is further achieved in comparison to the coating result by means of step b:
a reduced roughness; and
an increased surface density,
wherein preferably this at least one property is achieved in step c.

15. Manufacturing method according to claim 12, wherein the refinement layer comprises an adhesive layer and a functional layer, preferably a friction layer, wherein the adhesive layer is arranged between the treatment surface and the functional layer.

16. Manufacturing method according to claim 15, wherein
in step c. the stresses in the adhesive layer, preferably exclusively in the adhesive layer with respect to the refinement layer, are reduced.

17. Workpiece with a refinement layer, wherein the workpiece has a support body with a treatment surface, wherein a refinement layer is applied to the treatment surface,
wherein
the refinement layer is re-compressed.

18. Workpiece with a refinement layer, wherein the workpiece has a support body with a treatment surface, wherein a refinement layer is applied to the treatment surface,
wherein
the stress in the refinement layer is neutral or compressive stress.

19. Workpiece according to claim 17, wherein the workpiece is finished by means of said manufacturing method.

20. Workpiece according to claim 17, wherein the workpiece is a rotary workpiece with an axis of rotation, preferably a brake disc for a motor vehicle.

21. Workpiece according to claim 17, wherein
the refinement layer comprises an adhesive layer and a functional layer, preferably a friction layer, wherein the adhesive layer is arranged between the treatment surface and the functional layer.

22. Workpiece according to claim 21, wherein
the adhesive layer, preferably exclusively the adhesive layer with respect to the refinement layer, is re-compressed and/or the stress in the adhesive layer, preferably exclusively the adhesive layer with respect to the refinement layer, is neutral or a compressive stress.
